(19) United States
(12) Patent Application Publication
(10) Pub. No.: US 2021/0066969 A1
(43) Pub. Date: Mar. 4, 2021

(54) All-in-one Wireless Charger

(71) Applicant: Shen Zhen Shi Aiker Electronic Technology co., LTD., Shenzhen (CN)

(72) Inventor: Yao Sun, Wanyuan (CN)

(21) Appl. No.: 17/095,771

(22) Filed: Nov. 12, 2020

(30) Foreign Application Priority Data
Oct. 22, 2020 (CN) 202022372526.6

(51) Int. Cl. H02J 50/40; H02J 50/10; H02J 7/00

(52) U.S. Cl. CPC H02J 50/402; H02J 7/0044; H02J 50/10

(57) ABSTRACT

The utility model discloses an all-in-one wireless charger, which comprises a power plug, a branch carrier, a plurality of wireless mobile phone charging trays and a watch magnetic wireless charging tray, wherein the power plug is connected to the branch carrier through a main line, and the branch carrier is connected to the wireless mobile phone charging trays and the watch magnetic wireless charging tray through corresponding branch lines; and the wireless mobile phone charging tray is internally provided with a wireless charging coil, a mounting bracket is arranged around the wireless charging coil in a sleeved mode, and the mounting bracket is provided with a plurality of magnet blocks in an annular array. The mounting bracket provided with the magnet blocks is arranged around the wireless charging coil, and the magnet blocks on the mounting bracket magnetically attract a magnet on a mobile phone.

### BACKGROUND OF THE INVENTION

### 1. Technical Field

The utility model relates to the technical field of wireless chargers, in particular to an all-in-one wireless charger.

### 2. Description of Related Art

It is well known that with the development of science and technology, mobile phones are becoming increasingly advanced and intelligent, and additional functions are available now. For example, the wireless charging function is already a mature technology for mobile phones.

Some recently introduced smart phones use a MagSafe system for wireless charging. Compared with a conventional wireless charging system, the MagSafe system is mainly characterized by utilizing the magnetic charging principle, that is, the charging position is located through magnetic effect, so that a wireless charging coil is kept in the most suitable position, thus ensuring the wireless charging efficiency. However, there is no matching wireless charger at present; besides, most of the existing wireless chargers can only charge a single mobile phone, resulting in a poor user experience.

### BRIEF SUMMARY OF THE INVENTION

In view of the above shortcomings in the prior art, the utility model aims to provide an all-in-one wireless charger.

In order to achieve the above purpose, the utility model adopts the following technical scheme:

An all-in-one wireless charger comprises a power plug, a branch carrier, a plurality of wireless mobile phone charging trays and a watch magnetic wireless charging tray. The power plug is connected to the branch carrier through a main line, and the branch carrier is connected to the wireless mobile phone charging trays and the watch magnetic wireless charging tray through corresponding branch lines.

The wireless mobile phone charging tray is internally provided with a wireless charging coil, a mounting bracket is arranged around the wireless charging coil in a sleeved mode, and the mounting bracket is provided with a plurality of magnet blocks in an annular array. The wireless charging coil is electrically connected to a circuit board, and the circuit board is installed in the wireless mobile phone charging tray or the branch carrier.

Preferably, the branch lines and the branch carrier are connected in a plug-in manner.

Preferably, the branch lines and the branch carrier are connected through a magnetic attraction connector.

Preferably, the power plug is A male or TYPE-C and supports QC protocol, PD protocol and AFC protocol.

According to the above scheme, the mounting bracket provided with the magnet blocks is arranged around the wireless charging coil, and the magnet blocks on the mounting bracket magnetically attract a magnet on a mobile phone, so as to realize alignment and meet the requirement for magnetic charging of the mobile phone; at the same time, the combination of the plurality of wireless mobile phone charging trays and the watch magnetic wireless charging tray allows simultaneous charging and selective charging of multiple products, making it more convenient to use; and besides, the branch lines and the branch carrier can be disconnected, so that when only one wireless mobile phone charging tray or watch magnetic wireless charging tray is needed, other charging trays can be removed, thereby simplifying the product and avoiding the clutter of too many components.

### BRIEF DESCRIPTION OF THE SEVERAL VIEWS OF THE DRAWINGS

FIG. 1 is a structural diagram of an embodiment of the utility model;

FIG. 2 is a structural diagram of a wireless mobile phone charging tray according to an embodiment of the utility model;

FIG. 3 is a diagram of an internal structure of a branch carrier according to an embodiment of the utility model;

### DETAILED DESCRIPTION OF THE INVENTION

The embodiments of the utility model will be described in detail with reference to the drawings below, but the utility model can be implemented in many different ways defined and covered by the Claims.

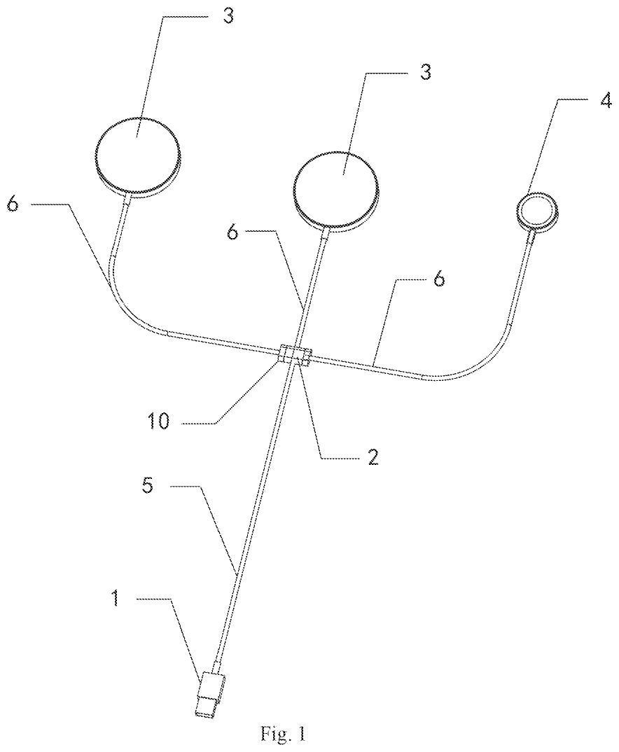

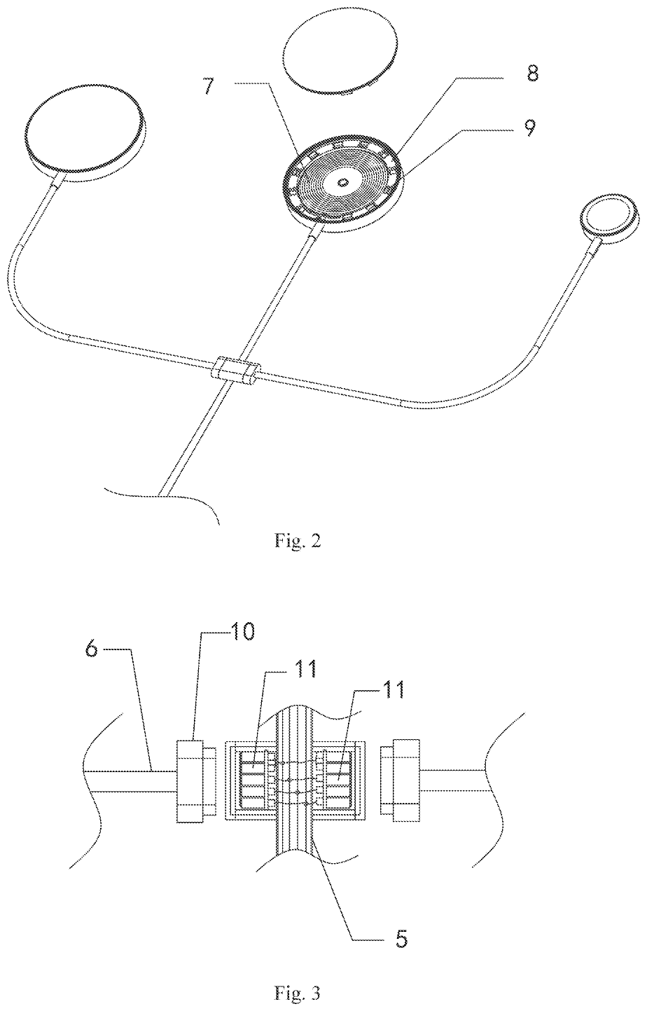

As shown in FIGS. 1 to 3, an all-in-one wireless charger provided by the embodiment comprises a power plug 1, a branch carrier 2, a plurality of wireless mobile phone charging trays 3 and a watch magnetic wireless charging tray 4. The power plug 1 is connected to the branch carrier 2 through a main line 5, and the branch carrier 2 is connected to the wireless mobile phone charging trays 3 and the watch magnetic wireless charging tray 4 through corresponding branch lines 6. Both the main line 5 and the branch lines 6 are conventional data lines with four or two, generally four built-in wires.

The wireless mobile phone charging tray 3 of the embodiment is internally provided with a wireless charging module 7, a mounting bracket 8 is arranged around the wireless charging module 7 in a sleeved mode, and the mounting bracket 8 is provided with a plurality of magnet blocks 9 in an annular array. The wireless charging module 7 is connected to the branch lines 6. Therefore, in the embodiment, the magnet blocks 9 on the mounting bracket 8 are used to magnetically attract a magnet on a mobile phone, so as to realize alignment, which meets the requirement for magnetic charging of the mobile phone and realizes a MagSafe system.

In the embodiment, the power plug 1 is used for electrical connection, and the power plug 1 can be of various forms, such as A male and TYPE-C. Supported protocols include QC protocol, PD protocol, AFC protocol, etc. Wireless charging is realized by means of the plurality of wireless mobile phone charging trays 3 and the watch magnetic wireless charging tray 4, wherein the number of the wireless mobile phone charging trays 3 and the number of the watch magnetic wireless charging tray 4 can be determined according to product specifications; that is, there may be a single watch magnetic wireless charging tray 4 and a plurality of wireless mobile phone charging trays 3, or a plurality of wireless mobile phone charging trays 3 and a single watch magnetic wireless charging tray 4, and of course, there may also be a plurality of wireless mobile phone charging trays 3 and a plurality of watch magnetic wireless charging trays 4. Therefore, the specific numbers of the wireless mobile phone charging trays 3 and watch magnetic wireless charging trays 4 are not limited in the embodiment.

Further, the branch lines 6 are connected to the branch carrier 2 in a plug-in manner. Specifically, the branch lines 6 are connected to the branch carrier through a magnetic attraction connector 10. Therefore, in the actual application of the embodiment, branch lines that are not needed can be pulled out according to the actual situation, so that the clutter brought by redundant parts is avoided.

In addition, it should be noted that the branch carrier 2 in the embodiment only serves as a fixing and connecting component, and an internal structure of the branch carrier is mainly used for realizing the connection between the main line 5 and the branch lines 6, as shown in FIG. 3. That is, the four wires of the main line 5 are connected to the four wires of each branch line 6 in series respectively, and if the magnetic attraction connector 10 is adopted, the four wires of the main line 5 are connected to pogo pins 11 of the magnetic attraction connector 10 respectively.

There is also another embodiment in which a circuit board of the wireless charging module 7 in the wireless mobile phone charging tray 3 is arranged in the branch carrier 2, so that only a wireless charging coil exists in the wireless mobile phone charging tray 3, and the circuit board is removed and connected to the wireless charging coil through a wire; in this way, the weight of the wireless mobile phone charging tray 3 is reduced, which facilitates magnetic attraction, and at the same time, heat dissipation is effectively improved and the influence of heat generated by the wireless charging coil on the circuit board is avoided.

The above are only preferred embodiments of the utility model, which do not limit the patent scope of the utility model. Any equivalent structure or equivalent flow transformation made by using the contents of the specification and drawings of the utility model, or direct or indirect application to other related technical fields, is equally included in the patent protection scope of the utility model.

What is claimed is:

1. An all-in-one wireless charger, characterized by comprising a power plug, a branch carrier, a plurality of wireless mobile phone charging trays and a watch magnetic wireless charging tray, wherein the power plug is connected to the branch carrier through a main line, and the branch carrier is connected to the wireless mobile phone charging trays and the watch magnetic wireless charging tray through corresponding branch lines;
the wireless mobile phone charging tray is internally provided with a wireless charging coil, a mounting bracket is arranged around the wireless charging coil in a sleeved mode, and the mounting bracket is provided with a plurality of magnet blocks in an annular array; and the wireless charging coil is electrically connected to a circuit board, and the circuit board is installed in the wireless mobile phone charging tray or the branch carrier.

2. The all-in-one wireless charger according to claim 1, characterized in that the branch lines and the branch carrier are connected in a plug-in manner.

3. The all-in-one wireless charger according to claim 2, characterized in that the branch lines and the branch carrier are connected through a magnetic attraction connector.

4. The all-in-one wireless charger according to claim 3, characterized in that the power plug is A male or TYPE-C and supports QC protocol, PD protocol and AFC protocol.
